(19) United States
(12) Patent Application Publication
(10) Pub. No.: US 2008/0261653 A1
(43) Pub. Date: Oct. 23, 2008

(54) Cellular phone with built-in IC tag reader

(76) Inventors: Hitoshi Hara, Tokyo (JP); Nobutoshi Nakano, Tokyo (JP)

Correspondence Address: BERENATO, WHITE & STAVISH, LLC, 6550 ROCK SPRING DRIVE, SUITE 240, BETHESDA, MD, 20817, US

(21) Appl. No.: 11/826,196

(22) Filed: Jul. 12, 2007

(30) Foreign Application Priority Data
Apr. 19, 2007 (JP) 2007-002799

(51) Int. Cl. H04M 1/02

(52) U.S. Cl. 455/557; 455/344

(57) ABSTRACT

A cellular phone having a main body with a built-in IC tag reader is disclosed. The built-in IC tag reader includes an IC tag reader chip having a function for reading IC tags, and a communications antenna for IC tag use connected to the IC tag reader chip.

### FIELD OF THE INVENTION

The present invention relates to a cellular phone having, in the main body thereof, a built-in IC tag reader which is capable of reading IC tags.

### BACKGROUND OF THE INVENTION

In recent years, IC tags have become widespread and various goods have an IC tag attached thereto. Among such items, cellular phones having an IC tag attached thereto are known. IC tags are a digital medium that use radio frequency identification (RFID) technology to keep track of items and automatically discriminate between various types of information through a wireless exchange of data between the IC-tag and an IC-tag reader.

Japanese published unexamined application 2003-46627 is an example of a cellular phone having an IC tag attached thereto. This publication describes a cellular phone having an IC tag attached to the chassis thereof which has a conductive layer therein for shielding the internal circuitry. The IC tag stores identification information which is capable of being read in a contactless manner.

### SUMMARY OF THE INVENTION

The present invention provides a cellular phone with a built-in IC tag reader having a function for reading IC tags. The present invention provides the convenience of reading IC tags, thereby further expanding cellular phone applications as well as further promoting the use of IC tags.

The invention provides a cellular phone having a main body with a built-in IC tag reader comprising an IC tag reader chip having a function for reading IC tags, and a communications antenna for IC tag use connected to the IC tag reader chip.

The built-in IC tag reader is configured to be supplied with electric power from a power source in the main body of the cellular phone. The built-in IC tag reader is also configured to be operated by a read application dedicated for IC tags, which is loaded in the main body of the cellular phone. Data read by the built-in IC tag reader is displayed on a display portion of the main body of the cellular phone.

The cellular phone may be a flip phone so that the main body is foldable between an open, unfolded position and a closed, folded position, and the built-in IC tag reader may be attached to the front portion of the main body when the flip phone is in the folded position.

The cellular phone is configured to be capable of accessing a website based on website access information which is read from an IC tag by the built-in IC tag reader.

Accordingly, the power source, an application loader function and the display portion of the main body of the cellular phone can be used also as those of a built-in IC tag reader, enabling simplified and low-cost configurations for IC tag readers.

Additionally, by attaching the IC tag reader to the front portion of the main body when the flip phone is in the folded position, the IC tag reading operation can be performed with ease. Moreover, the IC tag reader can be attached to a sub-display portion of a commercially-available cellular phone.

The cellular phone is capable of accessing a website based on the website access information which is read from an IC tag by the built-in IC tag reader, thereby being capable of receiving information distributed by the website as well as transmitting information to the website.

The present invention also provides a cellular phone, including a main body, an IC tag reader built in said main body for reading data from an external IC tag, a first communication interface for communication between the IC tag reader and the external IC tag, and a second communication interface for cellular communication of voice and data between the cellular phone and at least one cellular network.

A method of reading data in an IC tag is also provided. The method includes providing a cellular phone with a built-in IC tag reader, the cellular phone having an antenna associated with the IC tag reader for communication with IC tags. An IC tag is also provided within a predetermined proximity range of the antenna. Data from the IC tag is received via the antenna to the cellular phone.

### BRIEF DESCRIPTION OF THE DRAWINGS

FIG. 1A is an explanatory diagram of a cellular phone with a built-in IC tag reader of the present invention. FIG. 1B is an explanatory diagram showing the attachment position of the built-in IC tag reader in the cellular phone when the cellular phone is in a closed position.

FIG. 2A is an explanatory diagram showing the functions of the cellular phone with a built-in IC tag reader of the present invention. FIG. 2B is a plan view of a communications antenna for IC tag use having an approximate antenna size of 1.9 cm×0.8 cm.

FIG. 3 is an explanatory diagram showing a state in which a website is accessed by the cellular phone with a built-in IC tag reader of the present invention.

### DESCRIPTION OF THE PREFERRED EMBODIMENT(S)

Hereinafter, description will be made of the embodiments of the present invention with reference to accompanying drawings.

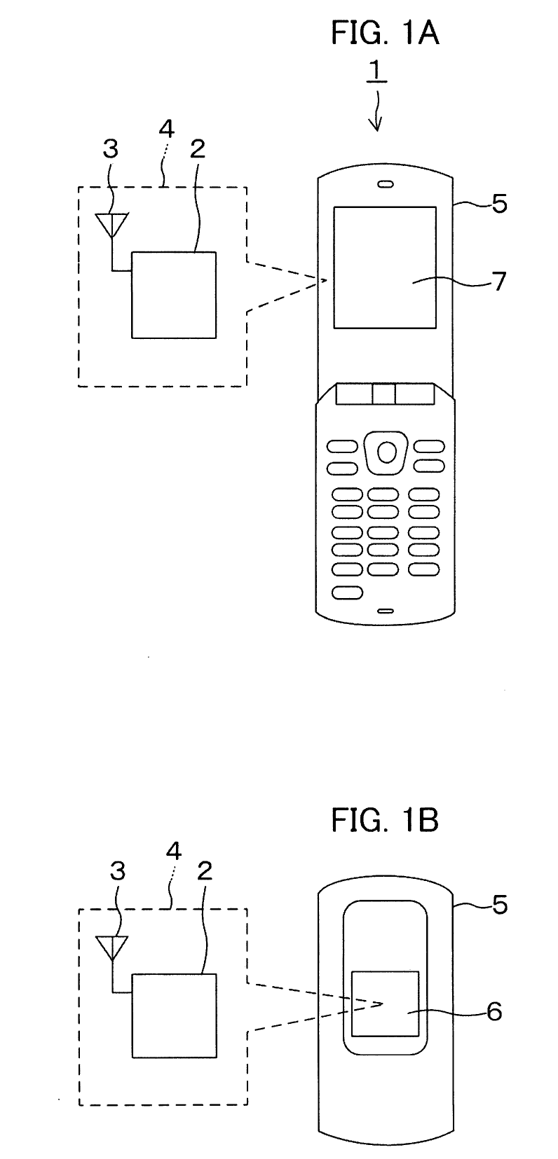

FIG. 1A illustrates a cellular phone 1 with a built-in IC tag reader 4 of the present invention. The cellular phone 1 with the built-in IC tag reader 4 has a main body 5 including the built-in IC tag reader 4. The built-in IC tag reader 4 has an IC tag reader chip 2 having a function for reading IC tags, and a communications antenna 3 for IC tag use connected to the IC tag reader chip 2.

An IC tag reader chip in compliance with ISO/IEC15693 and ISO/IEC14443 is used as the IC tag reader chip 2.

As shown in FIG. 1B, the built-in IC tag reader 4 is preferably attached to a flip phone. Moreover, the built-in IC tag reader 4 is attached to the front portion 6 of the main body 5 of the flip phone when the flip phone is in a folded or closed position. Accordingly, the built-in IC tag reader is attached to a sub-display of the flip phone which is visible when the flip phone is in the folded or closed position. Moreover, the built-in IC tag reader 4 may be attached to a commercially available flip phone having a sub-display attached thereto after detaching the sub-display therefrom.

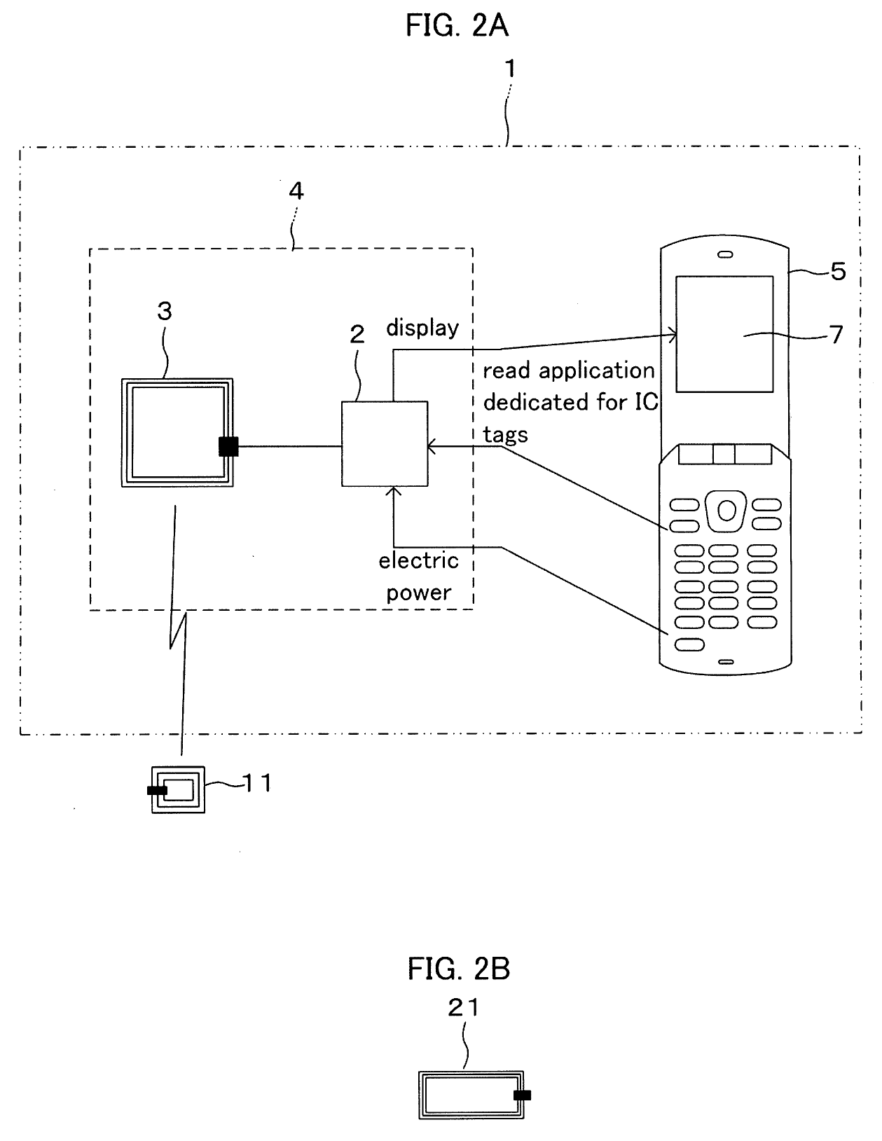

As shown in FIG. 2A, the built-in IC tag reader 4 is configured to be supplied with electric power from a power source in the main body 5 of the cellular phone 1. The built-in IC tag reader 4 is operated by a read application dedicated for IC tags, which is loaded in the main body 5 of the cellular phone 1. Additionally, display data read by the built-in IC tag reader 4 is displayed on the display portion 7 of the main body 5 of the cellular phone 1. Although not explicitly shown, the main body 5 also includes a controller for controlling overall operation of the cellular phone 1 and the components in the main body 5. The antenna 3 shown in FIG. 2A, which has an approximate antenna size of 2 cm×2 cm, is used to communicate with IC tag 11.

The data of the IC tag 11 can be read by holding the communications antenna 3 for IC tag use at a readable distance of, for example, a few mm to approximately 2 cm from the IC tag 11, which is located outside the cellular phone 1. A frequency of 13.56 MHz, for example, is used for communications between the IC tag 11 and the built-in IC tag reader 4.

When the power source in the main body 5 of the cellular phone is turned on, the built-in IC tag reader 4 is energized by the power source, and, by operation of the main body 5 of the cellular phone, a read application dedicated for IC tags is activated. Furthermore, by moving the communications antenna 3 for IC tag use close to the IC tag 11, the IC tag reader chip 2 reads the data of the IC tag 11 and displays the read data on the display portion 7 of the main body 5 of the cellular phone.

A longer distance can be used to read the IC tag 11 by using a larger antenna size for the communications antenna 3. If there is limited space available for attaching the built-in IC tag reader 4, a communications antenna 21 for IC tag use having an approximate antenna size of 1.9 cm×0.8 cm, as shown in FIG. 2B, for example, may also be used.

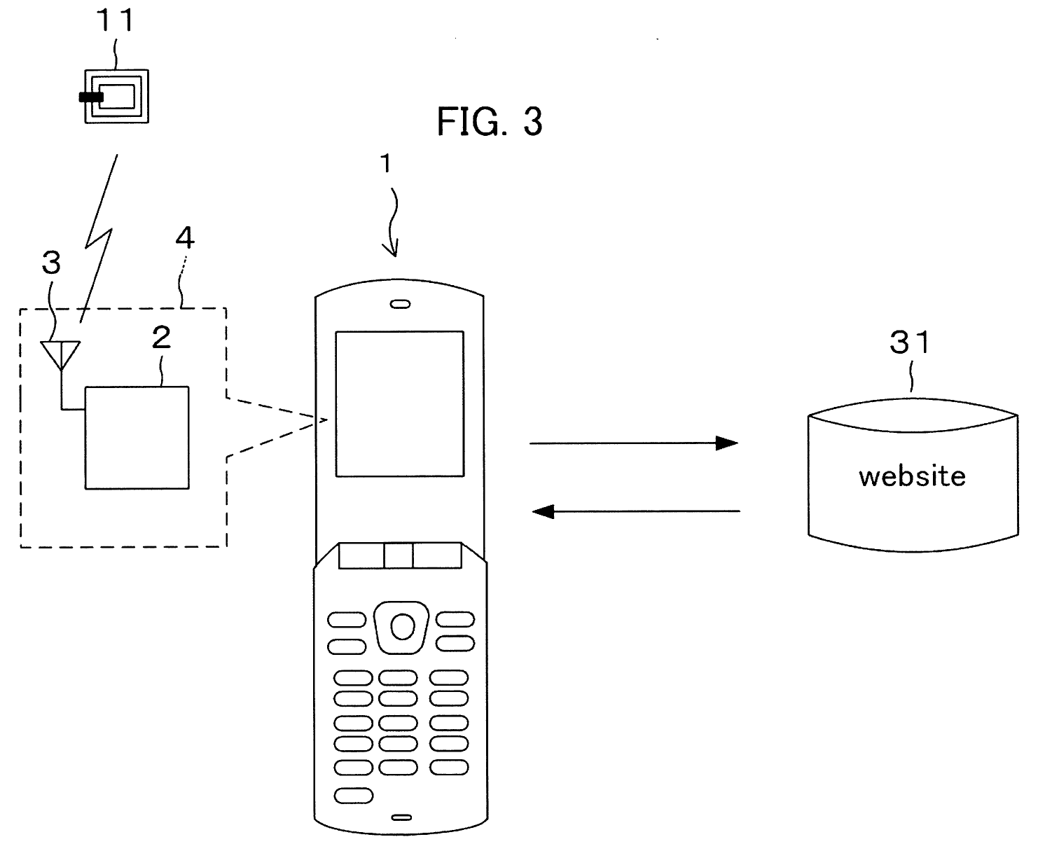

Moreover, the cellular phone 1 with a built-in IC tag reader 4 is configured to be capable of connecting to the internet and, as shown in FIG. 3, is capable of accessing a website 31 based on website access information which is read from the IC tag 11 by the built-in IC tag reader 4. Thus, the cellular phone 1 and the built-in IC tag reader 4 is thereby capable of receiving information distributed by the website 31 as well as transmitting information to the website 31.

Thus, by integrating the IC-tag reader chip 2 with the various components of the cellular phone 1, e.g., the display portion 7, the power source, the controller, an application loader for the cellular phone 1, the IC-tag reader 4 can be made with a simple structure and less components than conventional IC tag readers. Additionally, a user can immediately ascertain information about any item associated with an IC tag by simply applying it to the IC tag reader 4 in their cellular phone 1 to the IC tag and viewing the information on the display portion 7 of the cellular phone 1.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A cellular phone having a main body with a built-in IC tag reader, said built-in IC tag reader comprising:
an IC tag reader chip having a function for reading IC tags; and
a communications antenna for IC tag use, said communications antenna connected to said IC tag reader chip.

2. A cellular phone with a built-in IC tag reader as claimed in claim 1, wherein said built-in IC tag reader is configured to be supplied with electric power from a power source in said main body of said cellular phone.

3. A cellular phone with a built-in IC tag reader as claimed in claim 1, wherein said IC tag reader is configured to be operated by a read application dedicated for IC tags, which is loaded in said main body of said cellular phone.

4. The cellular phone with a built-in IC tag reader as claimed in claim 1, wherein display data read by said IC tag reader is displayed on a display portion of said main body of said cellular phone.

5. A cellular phone with a built-in IC tag reader as claimed in claim 1, wherein said cellular phone is a flip phone adjustable between an unfolded, open position and a folded, closed position having a front and rear portion, and said built-in IC tag reader is attached to the front portion of said main body of said flip phone when said flip phone is in the folded position.

6. A cellular phone with a built-in IC tag reader as claimed in claim 1, wherein said main body of said cellular phone is configured to be capable of accessing a website based on website access information which is read from an IC tag by said built-in IC tag reader.

7. A cellular phone with a built-in IC tag reader as claimed in claim 1, wherein said cellular phone is a flip phone adjustable between an unfolded, open position in which a main display is used and a folded, closed position in which a sub-display is used and said main display is not exposed, and said built-in IC tag reader is disposed on said sub-display portion of said flip phone.

8. A cellular phone, comprising:
a main body;
an IC tag reader disposed in said main body for reading data from an external IC tag;
a first communication interface for communication between the IC tag reader and the external IC tag; and
a second communication interface for cellular communication of voice and data between the cellular phone and at least one cellular network.

9. The cellular phone as claimed in claim 8, wherein the first communication interface comprises an antenna for short range wireless communications.

10. The cellular phone as claimed in claim 8, wherein the main body comprises a display for displaying information read from the external IC tag.

11. The cellular phone as claimed in claim 8, wherein the second communication interface is used by the cellular phone to access a website on the world wide web based on website access information which is read from the external IC tag.

12. The cellular phone as claimed in claim 8, wherein the main body has first and second portions foldable with respect to one another, and the IC tag reader is disposed outside of one of the first and second portions so as to be exposed when the first and second portions are folded together.

13. A method of reading data in an IC tag, said method comprising the steps of:
providing a cellular phone with a built-in IC tag reader, the cellular phone having an antenna associated with the IC tag reader for communication with IC tags;
providing an IC tag within a predetermined proximity range of the antenna; and
receiving data from the IC tag via the antenna to the cellular phone.

14. The method as claimed in claim 13, further comprising:
displaying the received data on a display of the cellular phone.

15. The method as claimed in claim 13, wherein the receiving of the data from the IC tag comprises receiving web address information from the IC tag.

16. The method as claimed in claim 15, further comprising:
accessing a website on the world wide web indicated by the received web address information.

17. The method as claimed in claim 16, wherein the accessing of the website comprises one of receiving information distributed by the website and transmitting information to the website.

18. The method as claimed in claim 13, wherein the receiving of the data from the IC tag comprises running a read application on the cellular phone when power to the cellular phone is turned on.
